(19) United States
(12) Patent Application Publication
(10) Pub. No.: US 2025/0208574 A1
(43) Pub. Date: Jun. 26, 2025

(54) HOROLOGICAL MOVEMENT PROVIDED WITH A MECHANISM FOR DRIVING A JUMPING INDICATOR

(71) Applicant: ETA SA Manufacture Horlogère Suisse, Grenchen (CH)

(72) Inventor: Théo PENNINO, Nidau (CH)

(73) Assignee: ETA SA Manufacture Horlogère Suisse, Grenchen (CH)

(21) Appl. No.: 18/942,857

(22) Filed: Nov. 11, 2024

(30) Foreign Application Priority Data
Dec. 21, 2023 (EP) 23219464.7

(51) Int. Cl. G04B 19/253

(52) U.S. Cl. CPC G04B 19/25353

(57) ABSTRACT

A horological movement includes an indicator, a mechanism for driving this indicator in jumps, a wheel platform having a first axis of rotation, a driving finger for driving the indicator, and a spring having a first end attached to the wheel platform for rotation therewith and a second end attached to the driving finger for rotation therewith. The mechanism includes a rigid support rotatable about the first axis of rotation relative to the wheel platform, and a lever mounted on the rigid support so as to be rotatable about a second axis of rotation which is distant from the first axis of rotation, and forming the driving finger. The mechanism limits the rotation of the lever in a first direction when the spring is being loaded and the indicator is making its next jump, the lever being able to rotate in the opposite direction to the first direction, thus allowing the driving finger to radially retract, towards the first axis of rotation, under the action of a radial force exerted on this driving finger.

### TECHNICAL FIELD OF THE INVENTION

The present invention relates to a horological movement provided with an indicator and comprising a mechanism for driving this indicator in jumps, and further relates to a watch incorporating a horological movement provided with such a mechanism. In particular, the indicator is a date indicator.

### TECHNOLOGICAL BACKGROUND

Patent document EP 3828644 describes a mechanism for driving a jumping indicator which advantageously overcomes technical problems of the prior art by comprising a rigid drum-finger, guided rotatably and translatably by a hub passing through an oblong hole in the drum, and a spring arranged in this drum-finger and connecting the latter to a wheel platform.

This drive mechanism has a number of drawbacks. Firstly, the spring expands when the date ring is driven and its coil is intended to bear against the interior wall of the drum when the spring is being loaded, so as to limit the expansion of the spring and prevent it from reaching the plastic range of the spring. This results in a sudden reduction in the active length of the spring. Given the manufacturing tolerances of the various components, the loading time of the drive mechanism can vary, as the time at which the spring comes into contact with the interior wall of the drum can vary from one loading to the next and the angular position of the contact zone can also vary. This leads to an inaccuracy in the time at which the ring is triggered to move on to the next date. Another problem arises from the fact that the driving force is transmitted to the finger via the coil of the spring, which must thus have sufficient rigidity/stiffness over its entire length and more particularly over the portion located between the contact zone with the wall of the drum and the coupling member for coupling with this drum, which is arranged at the second end of the spring, this portion ultimately having to withstand the entire additional torque generated from the moment of contact up to the moment when the indicator makes a jump.

The figures in the above-mentioned document show that the coupling member of the spring is arranged in a shallow recess from which this member can easily emerge. The two lateral surfaces of the recess are parallel in a radial direction passing through the middle of the recess and the coupling member has two radial flanks, the angular width of the coupling member being less than that of the recess to allow this member to penetrate easily into the recess. Moreover, the coupling member is intended to have a large amount of play in the recess, to allow this coupling member to move in the recess. Thus, a relatively small impact can easily result in the coupling member coming out of its recess. If this is the case, either when the spring is loaded bearing against a tooth of the date ring, or before loading this spring, which then typically exhibits slight expansion due to the friction exerted on the drum, the coupling member exits from the side of the finger radial driving flank. In this situation, the lateral wall of the drum exerts a radial force on the coupling member such that it is subjected to a frictional force on this lateral wall. If the coupling element comes out of its recess when the spring bearing against a tooth of the date ring is loaded, either it then slides along the inner lateral surface and the date jump will not occur until at least the drive wheel has made one revolution and the coupling element re-enters its recess (the best case scenario, which nonetheless results in the loss of a correct date display, which has missed a daily jump), or the frictional force is sufficient for the spring to expand again, further increasing the frictional force, until its coil touches the lateral wall and a date jump takes place at an indeterminate time. In the latter case, after the date jump, the spring will relax by driving the drum. If this situation recurs, the next date changes will no longer occur around midnight. If the coupling element undergoes a certain sudden angular displacement along the lateral wall, which is likely, then this situation will be repeated for at least a few days with date increments at indeterminate and variable times. In any event, the date drive mechanism will stop being functional for at least several days as soon as the coupling member is out of its recess, which event is highly probable for the mechanism as shown in the figures of patent document EP 3828644.

The geometry of the coupling member in relation to its recess, allowing a large amount of play and a certain mobility of the coupling member in the recess, creates another problem. More specifically, when the spring is loaded, it will deform the coil of the spring and cause the coupling member to rotate about itself. This rotation will cause the coupling member to slide against the front lateral wall of the recess such that the point of application of the force from the spring on the drum-finger is reduced radially as the spring is loaded. Thus, for a given level of spring loading, the driving torque provided by the spring on the finger decreases in proportion to the decrease in the application, by the lever arm, of the force from the spring on the drum-finger, which poses a problem because the driving force of the finger on the tooth of the indicator decreases in the same proportion for a given contact point. Since a given driving torque is required to make the indicator jump, the spring will have to generate a force that is all the greater since said lever arm decreases during the loading of the spring, which has a negative impact on the performance of the horological movement that loads the spring of the driving mechanism and must thus provide more torque. This also requires the spring to be more robustly dimensioned than necessary.

Finally, another problem with the mechanism in question arises from the fact that, when the indicator is driven, the coil of the spring exerts a radial force on the drum directed outwards in an area diametrically opposite the finger and thus substantially in the longitudinal direction of the oblong hole, which tends to move this finger away from the toothing of the ring. The finger is thus more likely to pass a tooth without the indicator being driven, particularly in the event of a small impact in such a situation. It should also be noted that such a situation reduces the angular path over which the finger can drive a tooth by remaining in contact, so that it is possible for the finger to pass the tooth before it receives a driving torque over an angular distance sufficient to ensure a jump in the date, the date ring remaining stationary in an intermediate position or returning back to its previous stable position once the finger has passed the tooth. Furthermore, reducing the lever arm for applying the driving force to the tooth requires, for a given driving torque, an increase in the drive force required, which requires the force supplied by the spring and thus its tension to also be increased.

### SUMMARY OF THE INVENTION

The purpose of the invention is to provide a mechanism for driving a jumping indicator, which mechanism overcomes at least some of the drawbacks of the prior art described above. The invention further aims to provide a horological movement provided with an indicator and comprising a mechanism for driving this indicator in jumps, which mechanism is efficient, which can be precise in each horological movement comprising such a mechanism, and whose operation is little or not at all disturbed by external stresses, for example by impacts.

In particular, the drive mechanism is intended to allow the indicator to be quickly corrected by another specific mechanism specific of the horological movement, with an additional torque generated by the presence of the drive mechanism, during the passage of one tooth or the successive passage of a plurality of teeth on the outer flank of a driving finger of the indicator, which torque is minimal and contains no sudden variations.

To this end, the invention relates to a horological movement provided with an indicator and comprising a mechanism for driving this indicator in jumps, the mechanism comprising a wheel platform defining a first axis of rotation, a driving finger for driving the indicator and a spring formed by a first end, a coil and a second end, the first end being attached to the wheel platform for rotation therewith and the second end being attached to the driving finger for rotation therewith at least during each loading of the spring preceding a jump by the indicator and the driving of the indicator by the mechanism during this jump. The mechanism comprises a rigid support, which is rotatable about the first axis of rotation relative to the wheel platform, and a lever mounted on the rigid support so as to be rotatable about a second axis of rotation which is distant from the first axis of rotation, the second axis of rotation being located at a first end of the lever and the driving finger being formed by this lever on the side of its second end. The mechanism further comprises a first stop which is integral with the rigid support and which limits the rotation of the lever in a first direction corresponding to the direction in which the finger moves radially away from the first axis of rotation, the lever being arranged so as to bear against the first stop at least when the spring is loaded before the indicator jumps and to be able to rotate in the second direction, opposite to the first direction, to allow the driving finger to be retracted, towards the first axis of rotation, under the action of a force exerted on this driving finger which has a progressively increasing radial component.

When the spring is being loaded, the first stop makes it possible to maintain a constant radial distance between the contact point of the driving finger on a tooth of the indicator and the first axis of rotation (central axis of rotation) of the mechanism. In contrast to the prior art, the leverage thus remains constant and the mechanism is more efficient.

In a particular alternative embodiment, the indicator is a date indicator comprising a toothing. In particular, the indicator is a date ring comprising an internal toothing in order to be driven rotatably by said mechanism.

Thanks to the driving finger, which is not integral with the rigid support but is rotatable about a second axis of rotation defined by the rigid support and distant from the first axis of rotation of the wheel platform and of the rigid support, a radial retraction of the driving finger in the direction of the first axis of rotation, under the action of a force exerted on this driving finger by the indicator, is obtained in this case by the rotation of the lever without radial displacement of the rigid support, it being possible for this lever to be relatively light and to exhibit relatively low friction during rotation. Thus, the force couple to be applied by a user making a rapid correction of the indicator, via a correction device other than said mechanism, in the intended drive direction or making a correction of the time (particularly in the case of a calendar indicator) in a counter-clockwise direction (which generates a rotation of the wheel platform in the opposite direction to the drive direction) and passing through midnight, is relatively weak and the passage of the indicator teeth over the driving finger, which retracts in a direction that is mainly radial relative to the central axis, is less noticeable than in the prior art.

Secondly, the resilient deformation of the spring can be lower than in the prior art and thus generate lower stresses in the spring, which is an advantage for the dimensioning of the spring, this being due to the rotation of the lever about the second axis of rotation with the driving finger moving mainly towards the first axis of rotation. The spring necessarily undergoes radial resilient deformation due to the radial retraction of the driving finger and thus of the second end of this spring; however, the angular deformation of the spring resulting from a force couple applied to this second end can be much less than in the case of the mechanism of the prior art. Advantageously, the interaction of the toothing on the finger applies a force on the rigid support through the lever only, and thus at the second off-centre axis of rotation. The direction of the force, generated by a tooth of the indicator pressing on the outer flank of the driving finger, which is applied at the second axis generates a torque on the rigid support, tending to make it rotate, which torque is weaker than in the prior art. Given the rigidity of the spring (which is necessary in order to store energy during normal driving of the indicator), the lever can rotate relative to the rigid support, under the action of a tooth pressing on the outer flank of the driving finger, without this rigid support being required to rotate relative to the wheel platform. It can thus be seen that the spring undergoes mainly radial resilient deformation due to the retraction of the driving finger by rotation about the second axis of rotation, which is distant from the first axis of rotation. The drive mechanism of the invention thus allows the same retraction of the finger, during a correction, as in the prior art, but it generates a lesser resilient deformation of the spring compared with the mechanism of the prior art where the spring undergoes significant angular deformation in addition to radial deformation.

The benefits of the invention set out above are remarkably obtained in an advantageous alternative embodiment, in which the outer flank of the driving finger is arcuate, this arcuate outer flank having, while the lever is in contact with the first stop, a dimension radial to the first axis of rotation which increases monotonically as it approaches a drive flank of the driving finger in order to press against a lateral flank of a tooth of the toothing during an incrementation of the indicator in jumps.

According to an advantageous alternative embodiment, the spring and lever are arranged in such a way that the lever also bears against the first stop when the spring is not under angular stress.

According to a main embodiment, the rigid support comprises a plate which forms the first stop. In particular, the rigid support is constituted by such a plate.

According to a preferred embodiment, the mechanism is arranged so that the spring contracts when this spring is loaded in order to be able to generate a jump, in particular a semi-instantaneous jump of the indicator. By contracting the spring, a constant radius can in particular be obtained for applying the driving force of the finger to the indicator tooth against which the finger bears, thereby optimising this driving force and thus the driving torque required to cause the indicator to jump.

According to an advantageous alternative embodiment, an angular displacement of the second end of the spring, and thus of the driving finger, relative to the wheel platform is limited, when the contracted coil is stressed as a result of the loading of the spring, by a second stop, defining an angular stop attached to the wheel platform for rotation therewith, the indicator and the mechanism being arranged such that a jump by the indicator occurs, in normal operation, after said angular displacement is stopped by the second stop, at the end of a loading of the spring preceding this jump, and thus corresponds to a determined angular distance.

The invention further relates to a watch incorporating a movement according to the invention.

### BRIEF DESCRIPTION OF THE FIGURES

The aims, advantages and features of the invention will be described in greater detail below with the aid of the accompanying drawings, which are given by way of non-limiting examples, in which:

FIG. 1 is a top view of a timepiece mechanism, according to an advantageous embodiment of the invention, which mechanism is intended to drive a jumping indicator, in particular in semi-instantaneous jumps;

FIG. 2 is an exploded, perspective view of the timepiece mechanism in FIG. 1;

FIG. 3 is a perspective view of a rigid support, of a spring and of a lever of the timepiece mechanism in FIG. 1, shown in an inverted position;

FIG. 4 is an enlarged, perspective view of the lever;

FIG. 5 is a view, similar to FIG. 1, of an alternative embodiment of the timepiece mechanism shown in FIG. 1;

FIG. 6A to 6D partially show a horological movement according to the invention, which movement incorporates the advantageous embodiment of the drive mechanism described in the preceding figures, respectively in four successive states occurring when a date ring is being driven by the drive mechanism;

FIGS. 7A and 7B partially show the horological movement in FIG. 6A in two successive states respectively, which states occur when the date ring is driven rapidly, by a conventional control member, in the date ring drive direction;

FIGS. 8A and 8B partially show the horological movement in FIG. 6A in two successive states respectively, which states occur when the time display hands are driven in a counter-clockwise direction and thus the wheel platform is driven in the opposite direction to the drive direction of this platform when the date ring is driven.

### DETAILED DESCRIPTION OF THE INVENTION

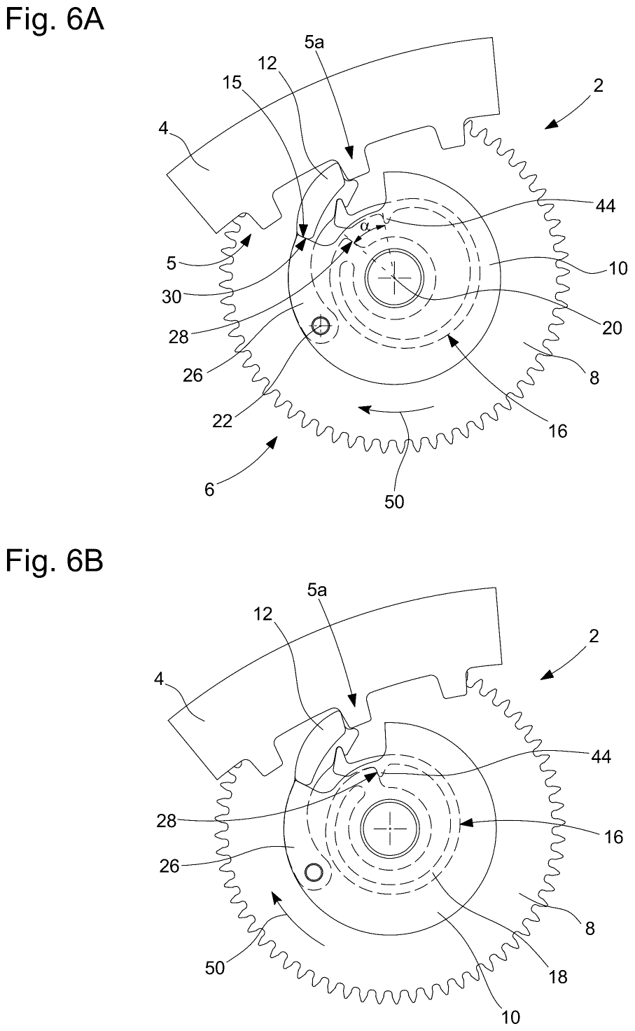

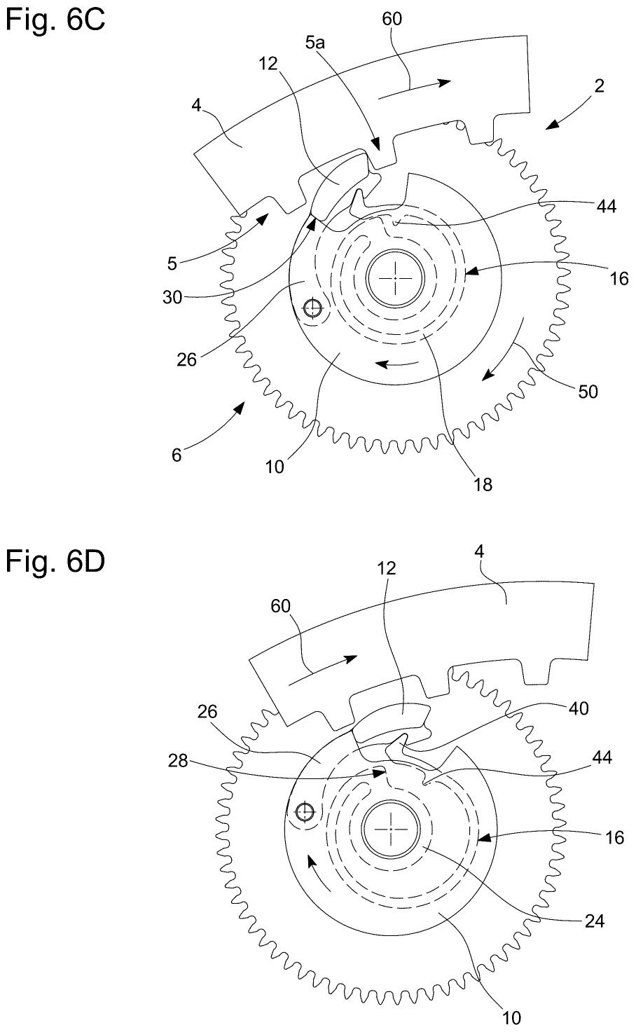

With reference to the accompanying drawings, one advantageous embodiment of a mechanism for driving an indicator in jumps, in particular in semi-instantaneous jumps, will be described and, more particularly with reference to FIG. 6A to 8B, the operation of a horological movement according to the invention incorporating such a drive mechanism will be described.

The mechanism 6 for driving a jumping indicator 4 comprises a wheel platform 8 rotating about a first axis of rotation 20, a driving finger 12 for driving the indicator, and a spring 16. In a main alternative embodiment, the indicator is a date indicator, in particular a date ring comprising an internal toothing 5. In other particular alternative embodiments, which are given by way of non-limiting examples, the indicator is, for example, a minute, hour, day or month indicator. The spring 16 is formed by a first end 17, a coil 18 and a second end 19, the first end being attached to the wheel platform for rotation therewith, and the second end being attached to the driving finger 12 for rotation therewith at least during each loading of the spring 16 preceding a jump by the indicator 4 and the driving of the indicator by the mechanism during this jump. The first end 17 of the spring is connected to a central part 24 which is attached to the wheel platform 8 for rotation therewith. Preferably, the spring and the central part form one and the same part. The mechanism 6 comprises a rigid support 10, which is rotatable about the first axis of rotation relative to the wheel platform, and a lever 26 mounted on the rigid support so as to be rotatable about a second axis of rotation 22 which is distant from the first axis of rotation 20.

The second axis of rotation 22 is located at a first end of the lever, which forms the driving finger on the side of its second end. In particular, the lever has, at its first end, a circular stud 34 which is inserted into a hole 33 made in the rigid support, so that the lever can rotate about the axis of rotation 22 defined by this hole 33, in particular to allow the driving finger 12 to retract during a rapid correction of the date or during a certain counter-clockwise correction of the time passing through midnight, as will be explained in more detail below.

The mechanism 6 comprises a central hub 32 defining a shaft which passes through a central hole in the rigid support 10 and guides this rigid support rotatably relative to the wheel platform 8, the latter and the central part 24 being driven onto the central hub 32.

Typically speaking, the drive mechanism comprises a first stop which is integral with the rigid support and which limits the rotation of the lever in a first direction corresponding to the direction in which the finger moves radially away from the first axis of rotation 20, the lever being arranged so as to bear against the first stop at least when the spring is loaded before the indicator jumps and, preferably, also when the indicator is driven during this jump, and to be able to rotate in the second direction, opposite to the first direction, and thus allow the driving finger to be retracted, towards the first axis of rotation 20, under the action of a tangential component, relative to the second axis of rotation 22, of a force exerted on this driving finger by the toothing of the indicator during a correction. Preferably, the spring and the lever are arranged in such a way that the lever also bears against the first stop when the spring is not under angular stress. According to a main alternative embodiment, the rigid support comprises a plate which forms the first stop. According to an advantageous alternative embodiment shown in the figures, the rigid support is the plate 10.

According to a particular alternative embodiment shown in the figures, the lever 26 is formed by an arm 36 and the driving finger 12, the arm having a first height and being arranged at least partially between the wheel platform and the plate. The driving finger 12 has a second height H at least in a thick part defining a drive flank 14 intended to bear against a tooth of a toothing 5 associated with the indicator 4 (FIG. 6A to 8B) when the indicator is driven by the mechanism 6. The second height H is greater than the first height and the thick part of the driving finger is not stacked on the plate for any useful angular position of the lever, this thick part extending axially at least partially over the thickness of at least one region of the plate located above the arm. The drive flank 14 is substantially radial to the first axis of rotation 20 when the lever is bearing against the first stop 30.

According to an advantageous alternative embodiment, the plate 10 has a lateral surface, a substantially radial zone whereof defines the first stop 30. The driving finger 12 has the second height H over its entire extent in the plane of the toothing 5 and is arranged so that its rear upper portion can come to bear against the first stop 30 at least each time the spring is loaded, so that it is then held in a fixed angular position relative to the second axis of rotation and thus in a fixed position relative to the first axis of rotation. In particular, the rear upper portion defines a stop surface 15 which cooperates with the first stop 30 to limit the rotation of the lever in the first direction of rotation, this stop surface 15 bearing against the first stop 30 at least each time the spring 16 is loaded and the indicator subsequently performs a jump, namely a date jump when the time display indicates midnight.

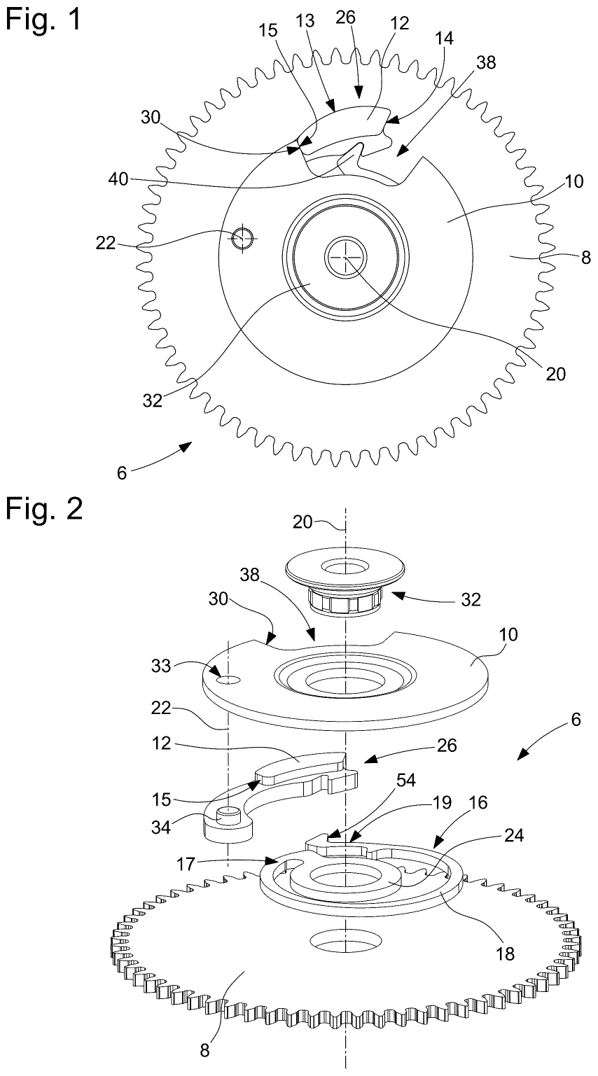

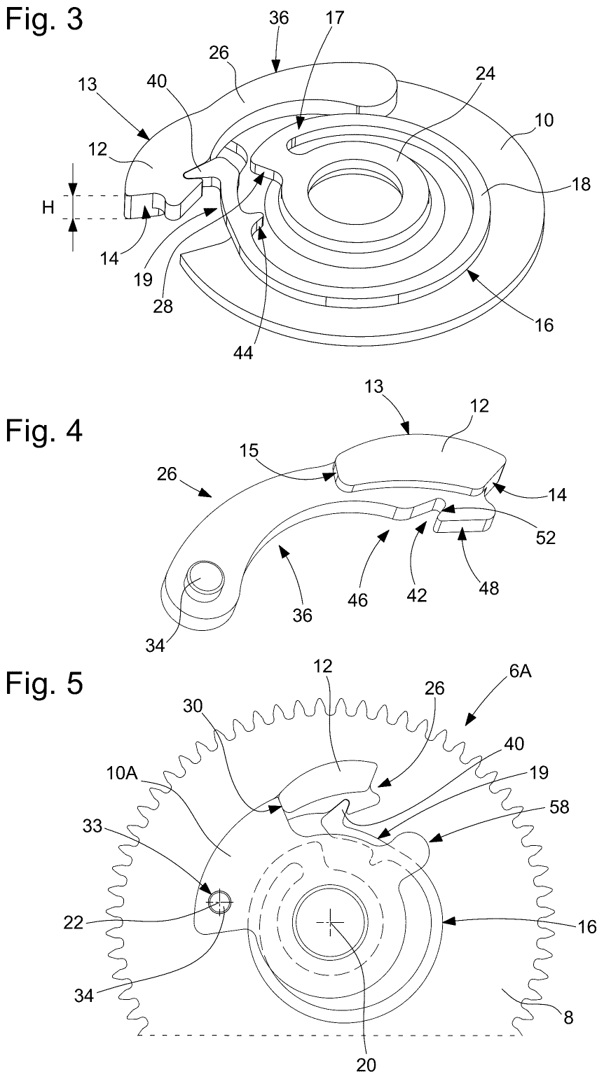

In the first alternative embodiment shown in FIGS. 1 to 3, the plate 10 has a profile that is circular overall with a lateral cavity 38, configured to allow the driving finger 12 to enter this cavity when a tooth passes along an outer flank 13 of this driving finger and thus to retract, with the most part of the spring 16 being covered at all times by the plate. In a second alternative embodiment shown in FIG. 5, the plate 10A of the mechanism 6A comprises: —a central part defining the central hole; —a projection 58 which covers part of the spring 16 on the side of its second end 19 to hold it in the general plane of the spring between the wheel platform 8 and the plate 10A; —a part in the form of an annular sector which extends radially from the central part and which defines, at a first angular end, the first stop 30 and, on the side of the second angular end, the hole 33 for the stud 34 of the lever 26.

In the alternative embodiments shown, the driving finger 12 has an arcuate outer flank 13 against which at least one tooth 5b of the toothing 5 of the indicator 4 can press during rapid correction of the indicator using a correction device other than the mechanism, the arcuate outer flank having, when the lever is in contact with the first stop 30, a dimension radial to the first axis of rotation 20 which increases monotonically as it approaches the drive flank 14.

According to an advantageous alternative embodiment, also shown in the figures, the lever 26 has, in an inner portion 46 running alongside the driving finger 12, a recess 42 having a lateral opening on the side of the spring 16. The second end 19 of the spring 16 is extended by a member 40 for coupling with the lever 26, this coupling member 40 being rigid and configured so as to be able to penetrate at least partially into the recess 42 and allow the spring to apply a driving force couple to the rigid support 10 and to the lever 26 so as then to allow the driving finger 12 to drive the indicator 4.

Preferably, the coupling member 40 is configured so as to be able to penetrate at least partially into the recess 42 through the lateral opening of this recess. In particular, the recess 42 has a lateral surface 52 oriented obliquely in the direction of rotation 50 of the wheel platform 8, in which direction the indicator 4 is intended to be driven, relative to a radial direction, relatively to the central axis of rotation 20, passing through the centre of this lateral surface, and the coupling member 40 has a lateral flank 54, facing the lateral surface 52, which is also inclined obliquely, relative to the central axis of rotation 20, in the same direction as the lateral surface and which bears at least partially against this lateral surface when the indicator is driven. The lateral surface and the lateral flank are relatively long. This particular feature ensures that the coupling member is held securely in the recess as soon as the spring 16 is contracted. In particular, the contact point or contact zone of the recess, on which point or zone the spring force is exerted, via the coupling member, does not vary when the spring is being loaded. Moreover, the coupling member 40 cannot rotate about itself, in the direction of rotation of the wheel platform, when the spring is being loaded.

The lever 26 advantageously has a lateral ramp 48 on the front part of the inner portion 46 allowing the coupling member 40 to be coupled to the lever 26, in particular to the driving finger, by inserting this coupling member into the recess 42, from an angular position of this coupling member located upstream of the lateral ramp 48, by simply rotating the plate 10 in a clockwise direction relative to the wheel platform 8.

The recess 42 is typically triangular in shape and opens out progressively towards its lateral opening. The shape of the part of the coupling member 40 which is inserted into the recess through the lateral opening corresponds substantially to that of the recess. This configuration advantageously allows the coupling member to be inserted easily into the recess, but would a priori allow this member to come out quite easily in the event of an impact, even though the recess is intended to be relatively deep. However, the spring 16 is arranged so that when this spring is loaded, the coupling member is at a short distance from the inner end 17 of the spring which is rigidly connected to the central part 24. In this situation, the coupling member 40 cannot come out of its recess in the event of an impact. Furthermore, when the driving finger does not interact with the toothing 5 of the indicator and the spring 16 is substantially relaxed, the coupling member 40 also cannot escape laterally from its recess in the event of an impact. The mechanism 6 is thus arranged so that, when the spring is relaxed or stressed during loading of this spring prior to the indicator jumping, the coupling member cannot move out of the recess 42.

Once inserted into the recess 42, the coupling member 40 can be held, although this is not mandatory, in this recess by a radial force, relative to the central axis of rotation 20, applied outwards by the spring 16 to this coupling member. This radial force (more precisely, the radial component of the force applied by the spring to the lever via the coupling member) is increased during a rapid change of the date or during a counter-clockwise time correction passing through midnight, by the fact that the driving finger and the coupling member are then retracted/withdrawn in the direction of the axis of rotation 20 via a clockwise rotation (second direction of rotation of the lever), such that the coupling member is thus normally held in the recess even when the spring 16 is somewhat expanded in such a situation.

When the driving finger 12 retracts, by a rotation of the lever 26 clockwise, during a rapid correction of the date or time in a counter-clockwise direction including a passage through midnight, the coupling finger moves closer to the central part 24 so that, after a certain initial rotation of the lever, the coupling member can no longer come out of its recess. During the initial rotation, the spring 16 can undergo a certain angular stress causing it to expand and theoretically allowing the coupling member to come out of its recess in the event of an impact. However, if the coupling member undergoes an acceleration substantially in the direction of the axis of rotation 20 of the wheel platform 8, the lever is then subjected to a certain force couple, which generates a rotation of this lever about its axis of rotation 22, and the driving finger then follows the coupling member so that the latter remains at least partially inside its recess. If the acceleration takes place in a direction passing substantially through the centre of gravity of the lever and its axis of rotation 22, the coupling member 40 can undergo a movement causing it to come out of the recess 42. However, an internal projection 44 of the spring can be configured in such a way as to prevent the coupling member from coming completely out of its recess. Alternatively, and advantageously, a rear part of the coupling member can be configured in such a way as to collide, during a correction, with a rigid part integral with the wheel platform before being able to completely come out of its recess. In conclusion, the mechanism 6 is arranged so that the coupling member 40 remains in its recess 42 during normal operation, so that this coupling member is at all times integral with the driving finger during normal operation, and so that in most cases it cannot come out of its recess during impacts, preferably not at all.

Preferably, the mechanism 6 is arranged so that the spring 16 contracts when this spring is loaded in order to be able to generate a jump by the indicator. Preferably, an angular displacement of the second end 19 of the spring 16, and thus of the driving finger 12 coupled to the coupling member 40, relative to the wheel platform 8 is limited, when the contracted coil 18 is stressed as a result of the loading of the spring, by a second stop 28, defining an angular stop attached to the wheel platform 8 for rotation therewith, the indicator and the mechanism being arranged such that a jump by the indicator does not occur, in normal operation, before said angular displacement is stopped by the second stop, at the end of a loading of the spring preceding this jump, and thus corresponds to a determined angular distance a (see FIG. 6A).

In the alternative embodiment shown, the spring 16 comprises an internal projection 44 arranged along the coil 18 on the side of its second end 19, this internal projection being arranged to come to bear against the second stop 28 (angular stop) and thus to put an end to the loading of the spring, and then to cause the indicator 4 to jump to its next stable position, namely to the next date in the case of a date indicator.

FIG. 6A to 8B show in more detail the operation of a horological movement 2, in particular the mechanism 6 for driving a date ring 4 incorporated into this horological movement. The central hub 32 has not been shown in these figures so as not to overload the drawing, but it is obviously necessary for the mechanism 6 to be functional.

FIG. 6A to 6D show four successive states of the mechanism 6 for driving the date ring 4 in jumps, in particular in semi-instantaneous jumps. FIG. 6A to 6D show the mechanism 6 and the date ring 4, when this ring is driven in order to change to a next date at midnight, respectively:
At the time when the driving finger 12 comes into contact with a tooth 5a of the ring 4 and the spring 16 is substantially angularly relaxed (i.e. not angularly stressed);
Once the loading of the spring 16 ends when the internal projection 44 of the spring comes to rest against the angular stop 28 after having undergone the angular displacement a relative to the wheel platform 8;
During the date jump generated by the mechanical energy stored in the contracted spring being applied to said assembly; and
At the end of the jump, when the date ring 4 has substantially reached its next stable position.

It should be noted that in a particular embodiment, in normal operation, a jump by the indicator occurs before the angular displacement of the spring is stopped by the angular stop 28. In such a case, the angular stop is a spring protection stop. In another particular embodiment, the drive mechanism does not have any angular stop. The spring contracts and the coil of this spring remains free to expand between the two ends of the spring during loading periods.

It should be noted that, in order to prevent a tooth 5a of the indicator 4 from passing over or under the driving finger 12 when the indicator is driven, it is provided that the height between the wheel platform 8 and the underside of the toothing 5, including play, remains constantly between the lower height and the upper height of the driving finger from the wheel platform, including play. To this end, in an advantageous alternative embodiment, the lower height of the finger is smaller than the thickness of the teeth of the toothing 5. Preferably, in a watch incorporating the horological movement 2, the distance between the upper height of the finger and a dial covering the drive mechanism and the indicator is also designed to be smaller than the thickness of the teeth of the toothing 5. The large height of the finger 12, which can rise at least from the underside of the spring 16 to above the plate 10 which defines the upper surface of the mechanism 6, makes it easy to prevent a tooth 5a passing under or over the finger 12.

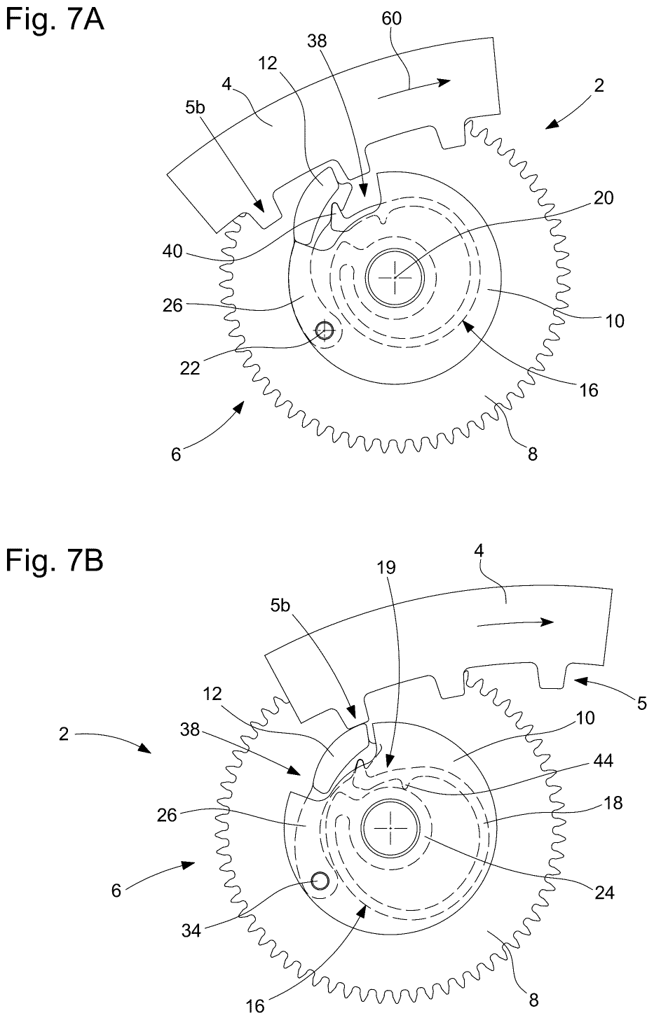

FIGS. 7A and 7B show the behaviour of the mechanism 6 during rapid correction of the date ring 4, by means of a control member that can be operated by a user in the conventional way, in the evening in which the wheel platform 8 and the plate 10 are for example initially in the configuration shown in FIG. 7A, so that the finger 12 is located between the tooth 5a and the tooth 5b that precedes it relative to the direction of rotation 60, so that the finger 12 is in the path of the tooth 5b of the indicator. The ring 4 is intended to advance rapidly in the direction of rotation 60 corresponding to the single direction of rotation of the date ring. As shown in FIG. 7B, the tooth 5b of the toothing 5 comes into contact with the arcuate outer flank 13 of the finger 12 when the ring 4 is rotated, and then exerts a progressively radial force on this finger, which causes the lever 26 to rotate clockwise about its axis of rotation 22 and thus causes the finger 12 to move towards the central hub of the plate 10, so that the finger is retracted towards the axis of rotation 20. This retraction is made possible by the configuration of the driving finger 12 and the profile of the lateral cavity 38 provided in the plate 10, as well as by the arrangement of the spring 16 and of the central part 24 to which it is attached and by the configuration of the internal projection 44. As can be seen in FIG. 7B, the finger 12 retracts as the tooth 5b passes, allowing this tooth to follow the outer flank 13 of the finger until this tooth protrudes angularly beyond the finger.

As already explained, the interaction of the toothing 5 on the driving finger 12 applies a force on the plate 10 through the lever 26 only, and thus at the second axis of rotation 22. The direction of the force, generated by a tooth 5a or 5b of the indicator pressing on the outer flank 13 of the driving finger, which is applied at the second axis of rotation generates a torque on the plate, tending to make it rotate, which torque is weaker than in the prior art. Given the rigidity of the spring 16, the lever 26 can rotate relative to the plate, under the action of a tooth pressing on the outer flank of the driving finger, without this rigid support rotating significantly relative to the wheel platform. It can be seen that the spring undergoes mainly radial resilient deformation, relative to the central axis of rotation 20, due to the retraction of the driving finger 12 by rotation about the second axis of rotation 22, which is distant from the first axis of rotation 20 (central axis of rotation of the mechanism). The drive mechanism 6 thus allows the same retraction of the finger, during a correction, as in the prior art, but it generates a lesser resilient deformation of the spring 16 than in the mechanism of the prior art where the spring undergoes significant angular deformation in addition to radial deformation. Thus, the work that must be supplied by the date ring 4 to the mechanism 6 to allow a tooth 5b to pass over the driving finger 12 (in a plane perpendicular to the axes of rotation 20 and 22), during the correction in question, is less than in the case of a driving finger with a similar profile but which is fixed relative to a plate having an oblong hole through which a central shaft passes, which shaft is in particular formed by a hub, as in the prior art.

As the finger 12 moves radially, the spring 16 contracts radially and the coupling member 40 moves closer to the central part 24. It should be noted that the spring 16, more precisely its coil 18, is also expanded slightly during the rapid correction of the date ring, simultaneously with the radial stress to which the spring is subjected in the direction of the axis of rotation of the wheel platform. However, given the profile of the outer flank 13 of the finger 12 and the rotation of this finger in the direction of the axis of rotation 20 (first axis of rotation, which is central) as explained above, the stress of the expanding spring is relatively small, or even practically zero depending on the configuration of the system. This is highly advantageous for the design of the spring 16, which can thus be arranged so as to be able to withstand as well as possible the contraction occurring when the indicator 4 is driven by the device 6, without also having to ensure that this spring behaves appropriately for a significant expansion stress.

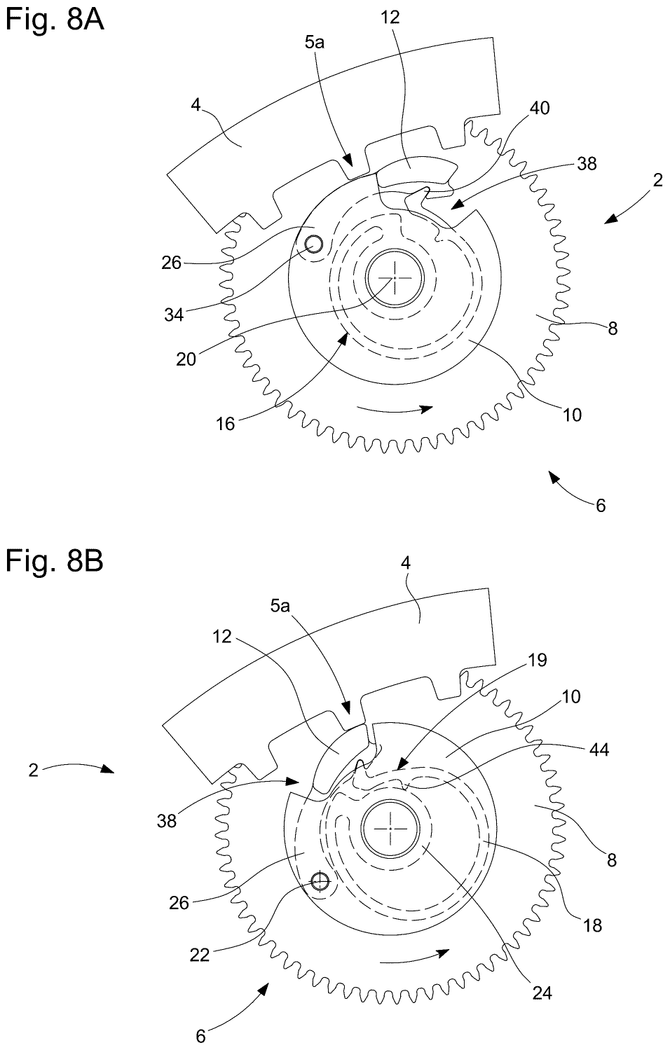

FIGS. 8A and 8B show the behaviour of the mechanism 6 during a correction of a time displayed by the timepiece mechanism, which rotates the wheel platform 8 in a counter-clockwise direction through midnight. In this case, the date ring 4 remains stationary in the stable position in which it was when the time was corrected. The succession of states of the mechanism 6 is similar to that which takes place during the rapid correction of the date display described above. When the wheel platform 8, and thus the assembly formed by the plate 10 and the lever 26, rotates in a direction opposite to the normal direction of rotation (corresponding to the clockwise direction of the time display), the arcuate outer flank 13 of the finger 12 comes to bear against a tooth 5a of the toothing 5 (FIG. 8A) and the plate 10 continues to rotate, however a little slower than the wheel platform due to a small expansion of the spring at least in an initial phase, while the driving finger moves radially towards the axis of rotation 20 via a clockwise rotation of the lever 26 which penetrates deeper into the lateral cavity 38, so that this finger retracts while the unmoving tooth 5a runs along the outer flank 13 of the finger.

The mechanism 6 is configured to prevent blocking during rapid date correction or counter-clockwise time correction.

The invention further relates to a watch comprising a horological movement 2 according to the invention, which movement is incorporated into a case, this case also incorporating a dial arranged in such a way as to allow the display of an item of data that changes over time by way of jumps, in particular the date.

1. A horological movement provided with an indicator and comprising a mechanism for driving said indicator in jumps, the mechanism comprising a wheel platform rotating about a first axis of rotation, a driving finger for driving the indicator, and a spring formed by a first end, a coil and a second end, the first end being attached to the wheel platform for rotation therewith, and the second end being attached to the driving finger for rotation therewith at least during each loading of the spring preceding a jump by the indicator and the driving of the indicator by the mechanism during said jump; wherein the mechanism comprises a rigid support, which is rotatable about the first axis of rotation relative to the wheel platform, and a lever mounted on the rigid support so as to be rotatable about a second axis of rotation which is distant from the first axis of rotation, the second axis of rotation being located at a first end of the lever, and the driving finger being formed by said lever on the side of its second end, the mechanism comprising a first stop which is integral with the rigid support and which limits the rotation of the lever in a first direction corresponding to the direction in which the driving finger moves radially away from the first axis of rotation, the lever being arranged so as to bear against the first stop at least when the spring is loaded, and to be able to rotate in the second direction, opposite to the first direction, to allow the driving finger to be radially retracted, towards the first axis of rotation, under the action of a force exerted on said driving finger, which force has a gradually increasing radial component.

2. The horological movement according to claim 1, wherein the spring and the lever are arranged in such a way that the lever also bears against the first stop when the spring is not under angular stress.

3. The horological movement according to claim 1, wherein the rigid support comprises a plate which is rotatably guided about the first axis of rotation by a shaft attached to the wheel platform for rotation therewith, the plate forming the first stop.

4. The horological movement according to claim 3, wherein the lever is formed by an arm and the driving finger, the arm having a first height and being arranged at least partially between the wheel platform and the plate, the driving finger having a second height at least in a thick part defining a drive flank intended to bear against a tooth of a toothing associated with the indicator when the indicator is driven by the mechanism, the second height being greater than the first height and the thick part of the driving finger not being stacked on the plate for any useful angular position of the lever, said thick part extending axially at least partially over the thickness of at least one region of the plate located above the arm.

5. The horological movement according to claim 4, wherein the plate has a lateral surface, one zone of which defines the first stop, the driving finger being arranged so that a rear upper portion of the thick part of said driving finger can come to bear against the first stop at least each time the spring is loaded, in such a way that it is thus held in a fixed angular position relative to the second axis of rotation and thus in a fixed position relative to the first axis of rotation.

6. The horological movement according to claim 4, wherein the plate has a profile that is circular overall with a lateral cavity, configured to allow the driving finger to enter said cavity when a tooth passes along an outer flank of the driving finger and thus to retract, with the most part of the spring being covered at all times by the plate.

7. The horological movement according to claim 4, wherein the driving finger has an arcuate outer flank against which at least one tooth of the toothing can press during rapid correction of the indicator using a correction device other than the mechanism, the arcuate outer flank having, when the lever is in contact with the first stop, a dimension radial to the first axis of rotation which increases monotonically as it approaches the drive flank.

8. The horological movement according to claim 1, wherein the mechanism is arranged so that the spring contracts when said spring is loaded in order to be able to generate a jump by the indicator.

9. The horological movement according to claim 8, wherein the spring comprises an internal projection arranged along the coil on the side of its second end, said internal projection being arranged to come to bear against a second stop, defining an angular stop that is attached to the wheel platform for rotation therewith, at the end of the loading of the spring and before the indicator makes a jump.

10. The horological movement according to claim 1, wherein the first end of the spring is connected to a central part which is attached to the wheel platform for rotation therewith.

11. The horological movement according to claim 1, wherein the lever has, in an inner portion on the side of the driving finger, a recess having a lateral opening on the side of the spring; and wherein the second end of the spring is extended by a member for coupling with the lever, said coupling member being rigid and configured so as to be able to penetrate at least partially into the recess through the lateral opening and allow the spring to apply a driving force couple to the lever and thus allow the driving finger to drive the indicator.

12. The horological movement according to claim 11, wherein the recess has a lateral surface oriented obliquely in the direction of rotation of the wheel platform, in which direction the indicator is intended to be driven, relative to a radial direction, relatively to the first axis of rotation, passing through the centre of said lateral surface, and the coupling member has a lateral flank, facing the lateral surface, which is also inclined obliquely, relative to the first axis of rotation, in the same direction as the lateral surface and which bears at least partially against said lateral surface when the indicator is driven.

13. The horological movement according to claim 1, wherein the indicator is a minute indicator, hour indicator, date indicator, day indicator or month indicator.

14. The horological movement according to claim 13, wherein the indicator is a date ring.

15. A watch comprising a horological movement according to claim 1.
